(19) United States
(12) Patent Application Publication
(10) Pub. No.: US 2007/0082127 A1
(43) Pub. Date: Apr. 12, 2007

(54) PROCESS FOR PRODUCING A STRUCTURED METAL LAYER ON A SUBSTRATE BODY

(75) Inventors: Harald Gundlach, Grunwald (DE); Andreas Muller-Hipper, Regensburg (DE); Ewald Simmerlein-Erlbacher, Pegnitz (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/608,663

(22) Filed: Dec. 8, 2006

Related U.S. Application Data
(62) Division of application No. 10/917,554, filed on Aug. 12, 2004.
Application No. 10/917,554 is a continuation of application No. PCT/DE02/03305, filed on Sep. 5, 2002.

(30) Foreign Application Priority Data
Sep. 17, 2001 (DE) 101 45 749.9

(51) Int. Cl. B05D 1/36; B05D 3/00; B05D 3/12

(52) U.S. Cl. 427/205; 427/264; 427/355

(57) ABSTRACT

Process for producing a structured metal layer on a substrate body, in which either a structured bonding layer is applied to the substrate body, in order for a metal foil or a metal powder to be fixed on this bonding layer, or in which a metal foil or a metal layer is applied to the entire surface of a substrate body made from a plastics material and is pressed onto the substrate body with the aid of a structured, heated ram and fixed by a subsequent setting of the substrate body. The metal layer is structured by mechanical removal of those regions of the metal foil or of the metal powder which are not joined to the adhesive or to the substrate body.

### CROSS-REFERENCE TO RELATED APPLICATION

This application is a continuation of International Patent Application Serial No. PCT/DE02/03305, filed Sep. 5, 2002, which published in German on Apr. 3, 2003 as WO 03/028416, and is incorporated herein by reference in its entirety.

### FIELD OF THE INVENTION

The invention relates to a process for producing a structured metal layer on a substrate body, and to a substrate body produced using this process.

### BACKGROUND OF THE INVENTION

Structured metal layers are required, for example, in printed-circuit boards, in chip cards operated without contact, in RFID tags or in other substrates in which various electrical components are to be electrically connected to one another. There are various processes which can be used to produce structured metal layers at greater or lesser cost and in a shorter or longer time. In particular, it is a regular objective for the structured metal layers to have low electrical resistances and, in the case of antennas or flat coils, as are used, for example, in contactless chip cards or what are known as identity tags, for them to have high levels of accuracy with regard to their electrical properties.

Some processes for the production of a structured metal layer which are known from the prior art will be described below.

One known possible way of producing a structured metal layer of this type consists in applying a metal foil to a large surface area of a substrate body in a first working step and then structuring this metal foil. In DE 196 29 269 A1, it is proposed to print an etching resist onto the surface of the conducting material of a flexible laminate system which includes an insulation material and a conductor material applied to it, a screen-printing technique being used for the printing operation. Etching of the printed laminate system then takes place.

Another known process consists in the metal layer being vapour-deposited in a vacuum onto the substrate body or being produced by cathode sputtering. After one pass, the metal layer has a thickness of 0.1 μm, and even after a number of passes it does not exceed a thickness of 0.5 μm. The metal foil then has to be reinforced by electrodeposition. The structuring of the metal layer which has been produced over a large area in this way is effected by means of a photolithographic etching process. Apart from high production costs, this procedure has the drawback that the bonding between metal foil and substrate body is insufficient, and the structured metal foil can become detached.

DE 196 39 646 A1 also proposes a laminate comprising a metal foil and a dielectric layer, in which the metal layer of the substrate strip, on its surface which faces the dielectric layer, has toothed elements which engage in the dielectric layer in order to hold it in place. Before they are placed onto one another, the metal strip and the dielectric layer are structured in a similar way, for example by stamping, and are then joined without adhesive in the manner described above. The joining operation is effected using the toothed elements which engage and hook into the dielectric layer. One advantage of this procedure is that there is no need to use adhesive and, moreover, the working step of photolithographic structuring is eliminated. On account of the stamping step, the material thicknesses must not exceed 50 μm in each case.

Furthermore, it is known for conductive pastes in ready-structured form to be printed onto the substrate body. These pastes have the drawback of often having high electrical resistances and of being expensive if the conductive paste contains conductive silver particles. It is known from WO 99 65002 to use polymeric ink with conductive silver particles. DE 198 41 804 A1 proposes using a polymer solution by means of an ink-jet printer to produce the structured conductor layer.

Furthermore, there are known proposals which firstly involve stamping an antenna, for example, out of a metal foil and then securing this antenna to the substrate body. However, this procedure is unsuitable for production in large numbers, since a multiplicity of production tools are required, there is a high wastage of material, the metal foil has to have at least a predetermined minimum thickness and the time required to produce one unit is very long.

DE 198 10 809 C1 proposes applying a metal powder layer to the top side of a substrate sheet and then exposing the top side of the substrate sheet, which has been covered with the metal powder, by means of electromagnetic rays at the locations which correspond to the interconnects of the predetermined conductor structure, by means of an imaging unit. In the process, the metal powder is partially melted in the regions which have been exposed by the electromagnetic radiation, so that the powder is fixedly joined to the substrate sheet. Then, the substrate sheet is guided around a guide roll, so that the top side of the substrate sheet is directed downwards, the metal powder which has not joined to the substrate sheet dropping into a collection device under the force of gravity. This process makes it easy to achieve flexible production of different conductor structures. However, complete removal of the metal powder which is not joined to the substrate sheet purely under the force of gravity must be unlikely, and consequently the conductor structure will not be clearly defined or subsequent removal steps are required.

While production processes which are based on the screen-printing process produce what are known as thick films, only what are known as thin films can be produced in vacuum vapour-deposition and cathode sputtering processes. On account of the small cross-sectional dimensions, structured thin films can only be exposed to low current densities, and consequently they are used in particular in electronic weak-current applications. By contrast, for the conductor structure to be used in power electronics, structured metal layers with a correspondingly large cross section are required.

### SUMMARY OF THE INVENTION

The invention is based on an object of providing a different process for producing a metal layer on a substrate body, in which the production of a structured metal layer of any desired thickness can be achieved in a simple and time-saving manner.

Furthermore, it is also intended to provide a substrate body having a structured metal layer which can be produced at low cost and is highly reliable.

In a first variant, the inventive process for producing a structured metal layer on a substrate body comprises the following steps:
a bonding layer is applied to at least part of a surface of the substrate body,
a metal foil or a metal powder is applied to that surface of the substrate body which has been provided with the bonding layer and is fixed to the bonding layer, and
then the regions of the metal foil or of the metal powder which are not fixed to the bonding layer are mechanically removed, so that only the regions of the metal foil or of the metal powder which are fixed to the bonding layer remain, in correspondingly structured form, on the substrate body.

The process described can be used for substrate bodies made from any desired material, for example plastics, metal, glass and so on. The bonding layer is preferably designed as a layer of adhesive with good adhesion properties. The bonding layer can be applied to the substrate body for example using a screen-printing process, which is known per se, or using a ram-printing process. Of course, it would also be possible for the bonding layer initially to be applied to the entire surface and then to be structured photolithographically. However, applying the bonding layer by means of a printing process has the advantage of lower costs compared to a photolithographic process, on account of high working speeds and the fact that only small amounts of chemicals are used. The bonding layer used may in principle be any desired material, provided that its adhesive properties are such that, during the mechanical removal of the metal foil, the regions which are joined to the bonding layer are not also removed. The adhesive properties of the bonding layer are essentially responsible for the conductor structures which are to be produced having sharp contours.

According to the invention, the object on which the invention is based can also be achieved by the following steps:
a metal foil or metal powder is arranged on at least part of a surface of the substrate body,
the metal foil or the metal powder is pressed onto the substrate body by a heated, structured ram, the regions of the substrate body which are operatively connected to the ram being converted from a solid state into a viscous state,
the structured ram is removed from the metal foil or the powder-coated substrate material after a predetermined time, and then the substrate body sets again and the metal foil or the metal powder is fixedly joined to the substrate body at the previously viscous regions, and
the regions of the metal foil or of the metal powder which are not fixed to the bonding layer are mechanically removed, so that only those regions of the metal foil or of the metal powder which are fixed to the bonding layer remain on the substrate body, in correspondingly structured form.

In this process, it must be ensured that the substrate body consists of a material whose melting point is lower than the melting point of the metal foil or of the metal powder. This is because the heat which is released by the structured, heated ram has to be introduced via the metal foil or metal powder into the operative regions of the substrate body which are connected to the ram. If the metal foil were to start to melt as a result of the pressure applied by the ram, it is possible that a conductor structure with undefined electrical properties and an uneven surface would be formed. Therefore, it is preferable to use a substrate made from a plastics material.

Both processes are based on the idea of fixing a metal foil which is initially applied to the entire surface or a metal powder which is applied to the entire surface in the regions which correspond to the subsequent structured metal layer and mechanically removing the remaining regions of the metal foil or metal powder. The mechanical removal of those parts of the metal foil or metal powder which are not secured to the bonding layer is preferably effected by brushing, sucking or sweeping them off. The excess metal is preferably reused after suitable treatment.

The structured metal layer which has been fixed to the substrate body and comprises the metal foil or metal powder can, in a further configuration, be reinforced chemically and/or by electrodeposition in a manner which is known per se. For this purpose, the substrate body formed by the structured metal layer is introduced into a suitable metallization bath.

To carry out the process according to the invention, the metal foil or metal powder may consist of copper, brass or another metal. Metal foils and also metal powders comprising these materials are inexpensive. It is preferable to use metal foils which have a thickness of approximately 1 to 10 μm, preferably less than 4 μm. Alternatively, it is also possible to use a metal foil comprising gold. Metal foils comprising gold are available in thicknesses of approximately 0.1 μm and above. Metal powders are available from a thickness of approximately 0.1 μm upwards (and in special cases from as little as 20 nm).

Despite this low thickness, the metal foils are easy to handle with success, so that the processes according to the invention can be carried out without problems using simple means. In addition to the low costs resulting from the high working speeds and the possibility of using existing installations, the processes according to the invention are distinguished by the fact that there is intimate bonding between the metal foil and the bonding layer or between the metal foil and the substrate body. As a result, it is possible to produce components with a high level of reliability. The fact that there is little use of chemicals means that the processes are also environmentally friendly.

The substrate body according to the invention having a structured metal layer, in particular a metal foil, is distinguished by the fact that the metal layer is joined to a surface of the substrate body via a bonding layer, the thickness of the metal layer being less than 4 μm. Alternatively, the metal layer can be applied direct to a surface of the body.

In an advantageous configuration, a further metal layer may be provided on that side of the metal layer which is remote from the substrate body.

The low thickness of the metal foil results from the inventive process for producing the structured metal layer. For metal foils with a thickness of greater than 4 μm, it has been found that a mechanical removal, for example by brushing, may cause problems. Therefore, in the case of metal foils with a greater thickness, the mechanical removal may have to be assisted by a stamping operation.

With standard rolling processes, it is no longer possible to provide metal foils of the required thickness. In the optimum scenario, it is possible to produce metal foils with a thickness of approximately 20 μm by means of a rolling operation. The required thickness can be produced with rolled metal foils which are then processed further by beating.

Further features, details and advantages will emerge from the following description of details and of process steps of the inventive process for production of a structured metal layer on a substrate body, the figures of the drawing being illustrated in greatly enlarged form and not to scale.

### BRIEF DESCRIPTION OF THE DRAWINGS

FIG. 1A shows a first process step of a first variant of a process according to the invention for producing a structured metal layer on a substrate body,

FIG. 1B shows a process step which follows the process step shown in FIG. 1A,

FIG. 2A shows a process step of a second variant of the process according to the invention for producing a structured metal layer, and

FIG. 2B shows a process step of the second process variant which follows the process step shown in FIG. 2A.

### DETAILED DESCRIPTION OF THE PREFERRED MODE OF THE INVENTION

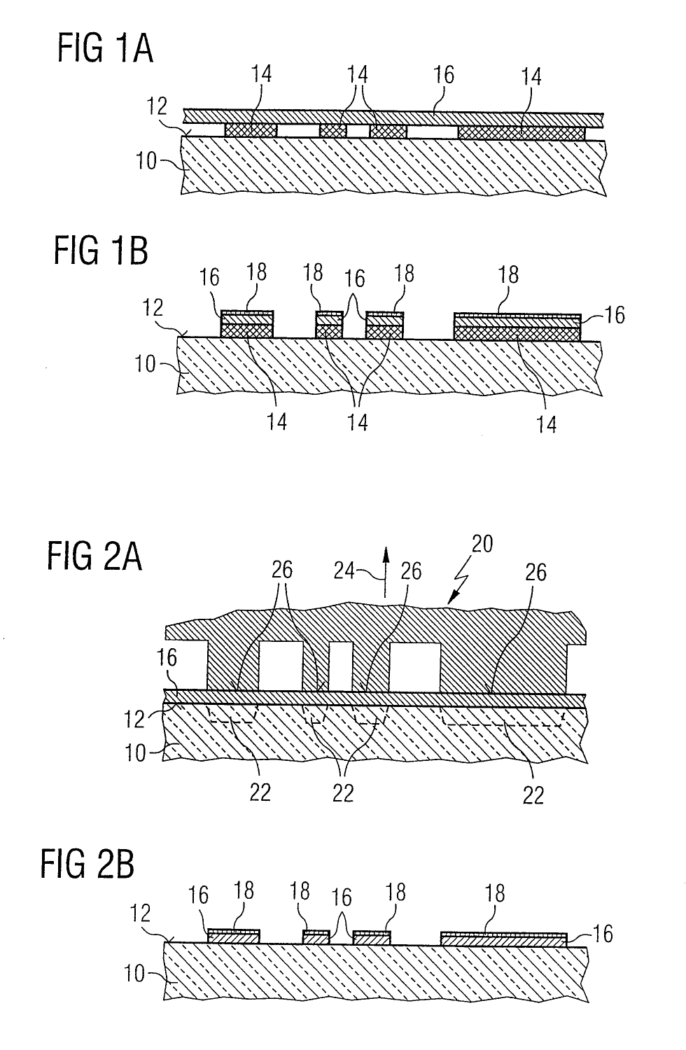

FIG. 1A illustrates, in excerpt and sectional form, a substrate body 10, to the surface 12 of which, in a first process step, an at least partially structured bonding layer 14, for example comprising an adhesive, resist or the like, has been applied. The substrate body 10 may consist, for example, of plastic, metal, ceramic, glass or any other desired material. Then, a metal foil 16 is applied to the entire surface of the substrate body 10 which has been provided with the structured bonding layer 14. The metal foil 16 is fixed to the surface 12 of the substrate body 10 with the aid of the structured bonding layer 14.

After the metal foil 16 has been fixed, those regions of the metal foil 16 which are not joined to the bonding layer—i.e. which lie laterally next to the structured layer of adhesive 14—are mechanically removed from the substrate body 10, which can be effected, for example, by brushing them off. The configuration of the substrate body following this step is illustrated in FIG. 1B. Therefore, only the metal 16 which has been fixed to the structured bonding layer 14 remains, in correspondingly structured form, on the surface 12 of the substrate body 10.

The structured metal layer 16, which is made, for example, from copper, brass, gold or the like, may be reinforced chemically and/or by electrodeposition. This is illustrated in FIG. 1B by the metallic reinforcing layer 18.

FIGS. 2A and 2B illustrate a second process variant, in which a substrate body 10 made from a suitable plastics material, with a lower melting point than the metal foil which is to be applied, is used. In this process variant, the metal foil 16 is arranged directly on the surface 12 of the substrate body 10. This foil is then pressed onto the substrate body 10 by a heated, structured ram 20, the substrate body 10 partially melting as a result of the heat conducted by the metal foil 16 to the surface layers 22 of the substrate body 10 which adjoin the structured ram 20 and are indicated by thin dashed lines in FIG. 2A. Then, the structured ram 20 is removed from the substrate body 10. This is indicated by the arrow 24 in FIG. 2A. After the structured ram 20 has been removed, the surface layers 22 set again, the metal foil 16 being fixedly joined to the substrate body 10 at the surface regions 26 which correspond to the structured ram 20.

Then, the excess, unfixed metal 16 which laterally adjoins the structured metal 16 which is fixedly joined to the substrate body 10 is mechanically removed from the substrate body 10, for example by being brushed off, so that only the fixed, structured metal foil 16 remains on the substrate body 10, as illustrated by the drawing shown in FIG. 2B. The structured metal foil 16 shown in FIG. 2B can then be reinforced chemically and/or by electrodeposition. A metallic reinforcing layer of this type is also denoted by reference numeral 18 in FIG. 2B.

1. A process for producing a metal layer on a substrate body, comprising the steps of:
applying a bonding layer to at least part of a surface of the substrate body;
applying a metal foil or a metal powder to the surface of the substrate body which has been provided with the bonding layer, thereby fixing the metal foil or the metal powder to the bonding layer; and
mechanically removing regions of the metal foil or of the metal powder that are not fixed to the bonding layer, so that only regions of the metal foil or of the metal powder that are fixed to the bonding layer remain, in correspondingly structured form, on the substrate body.

2. The process according to claim 1, wherein the bonding layer is a layer of adhesive.

3. A process for producing a metal layer on a substrate body, comprising the steps of:
arranging a metal foil or metal powder on at least part of a surface of the substrate body;
pressing the metal foil or the metal powder onto the substrate body by a heated, structured ram, wherein regions of the substrate body which are operatively connected to the ram are converted from a solid state into a viscous state;
removing the structured ram from the metal foil or the powder-coated substrate material after a predetermined period of time, and then allowing the substrate body to set again such that the metal foil or the metal powder is fixedly joined to the substrate body at the regions; and
mechanically removing regions of the metal foil or of the metal powder that are not fixed to the substrate body, so that only those regions of the metal foil or of the metal powder which are fixed to the substrate body remain on the substrate body, in correspondingly structured form.

4. The process according to claim 3, wherein the substrate body consists of a material whose melting point is lower than a melting point of the metal foil or of the metal powder.

5. The process according to claim 3, wherein the substrate body is made from a plastics material.

6. The process according to claim 1, wherein the mechanical removal of those parts of the metal foil or of the metal powder that are not fixed to the bonding layer is effected by brushing, sucking, or sweeping them off.

7. The process according to claim 3, wherein the mechanical removal of those parts of the metal foil or of the metal powder that are not fixed to the bonding layer is effected by brushing, sucking, or sweeping them off.

8. The process according to claim 3, wherein the structured metal layer is reinforced chemically and/or by electrodeposition.

9. The process according to claim 1, wherein the metal foil or the metal powder comprises copper, brass, or another metal.

10. The process according to claim 3, wherein the metal foil or the metal powder comprises copper, brass, or another metal.

11. The process according to claim 1, wherein the metal foil or the metal powder comprises gold.

12. The process according to claim 3, wherein the metal foil or the metal powder comprises gold.

13-16. (canceled)
